(19) United States
(12) Patent Application Publication
(10) Pub. No.: US 2024/0373190 A1
(43) Pub. Date: Nov. 7, 2024

(54) Geofencing for Non-Public Networks

(71) Applicant: Apple Inc., Cupertino, CA (US)

(72) Inventors: Tao Tao, San Jose, CA (US); Divyaprakash P. Bhojkumar, San Jose, CA (US); Li Li, Saratoga, CA (US); Raj S. Chaugule, Santa Clara, CA (US)

(21) Appl. No.: 18/310,164

(22) Filed: May 1, 2023

(51) Int. Cl. H04W 4/021; H04W 8/20

(52) U.S. Cl. CPC H04W 4/021; H04W 8/20; H04W 84/042

(57) ABSTRACT

Methods, devices, and systems for establishing a geofence for a Non-Public Network (NPN) using an Embedded Subscriber Identity Module (eSIM) associated with the NPN. The method includes receiving, by a receiver of a User Equipment (UE), an eSIM associated with an NPN, where the eSIM includes geofencing data. The UE performs wireless communication using the NPN when the UE is within an area defined by the geofencing data.

### FIELD

The present application relates to wireless devices and wireless networks, including devices, circuits, and methods for managing geofencing in non-public/private networks for wireless communication.

### BACKGROUND

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS) and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), HSPA, 3GPP2 CDMA2000 (e.g., 1×RTT, 1×EV-DO, HRPD, eHRPD), IEEE 802.11 (WLAN or Wi-Fi), and BLUETOOTH™, among others.

The ever-increasing number of features and functionality introduced in wireless communication devices also creates a continuous need for improvement in both wireless communications and in wireless communication devices. To increase coverage and better serve the increasing demand and range of envisioned uses of wireless communication, in addition to the communication standards mentioned above, there are further wireless communication technologies under development, including the fifth generation (5G) standard and New Radio (NR) communication technologies. Accordingly, improvements in the field in support of such development and design are desired.

Non-Public Networks (NPNs) are private networks that may be associated with enterprise (i.e., a business, factory, parks, etc.) and that operate over a specific geographical area. NPNs can provide specific features and access to users associated with the enterprise while in the area. In a typical NPN, a “geofence” may be established to define a virtual boundary for an NPN and to aide in the cell selection for a User Equipment (UE). By establishing the geofence, a UE may avoid cell selection delay and/or reduce the amount of battery consumption associated with searching for cells outside of the geofence area.

Typical geofences may include a single area or multiple, differently-sized areas. The implementation of geofences typically requires a geofence server to continuously feed the geofence data to the UE to aide in the cell searches. However, this type of geofence server may be too costly and/or simply unnecessary for geofence networks that do not update their virtual boundaries very often. Thus, further enhancements are desired.

### SUMMARY

The techniques described herein may be implemented in and/or used with a number of different types of devices, including but not limited to cellular phones, wireless devices, tablet computers, wearable computing devices, portable media players, Internet of Things (IoT) devices, vehicles, and any of various other computing devices.

In one aspect, embodiments relate to a method of geofencing in a wireless system that includes a UE receiving an embedded Subscriber Identity Module (eSIM) associated with a Non-Public Network (NPN). The eSIM includes geofencing data defining an area. The method includes performing wireless communication using the NPN when the UE is within the area defined by the geofencing data. The geofencing data may be stored as metadata in the eSIM, and the data may define multiple different areas.

In another aspect, embodiments related to a user device that includes a receiver that obtains an embedded Subscriber Identity Module (eSIM) associated with a Non-Public Network (NPN), where the eSIM includes geofencing data defining an area. A processor determines the user device is within the area defined by the geofencing data to perform wireless communication using the NPN

In another aspect, embodiments relate to a system that includes a Non-Public Network (NPN) server, the NPN server includes a processor that embeds geofencing data in an embedded Subscriber Identity Module (eSIM) associated with an NPN. The system includes a user device with a receiver that obtains the eSIM associated with the NPN established by the NPN server. The eSIM includes the geofencing data that defines an area. A processor of the user device determines the UE is within the area defined by the geofencing data to perform wireless communication using the NPN. In some embodiments, the system does not include a geofence server.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

A better understanding of the present subject matter may be obtained when the following detailed description of various aspects is considered in conjunction with the following drawings:

FIG. 1 illustrates an example wireless communication system, according to some aspects.

FIG. 2 illustrates an example block diagram of a UE, according to some aspects.

FIG. 3 illustrates an example block diagram of a Base Station (BS), according to some aspects.

FIG. 4 illustrates an example map of NPN established geofencing areas, according to some aspects.

FIG. 5 a flow chart for establishing UE services, according to some aspects.

While the features described herein may be susceptible to various modifications and alternative forms, specific aspects thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

There is a need to study enhancements to NPN in mobile services and mobile devices to provide geofence solutions with lower power, processing, and financial cost. For example, some enterprises may not move offices or extend chain locations often. As such, operating and maintaining a geofence server in traditional NPNs may be considered a large expense with a minimum return with respect to daily network operations.

In general, embodiments disclosed herein provide a method and system for an NPN that establishes a geofence using an eSIM associated with the NPN. As such, a boundary for the NPN may be established without the use (and cost) of a geofence server.

Embodiments disclosed herein improve on the current state of Global System for Mobile Communications Association (GSMA) protocols by using existing eSIM protocols to establish a geofence. The UEs may operate within Company Owned/Business Only (COBO), Company Owned/Personally Enabled (COPE), Choose Your Own Device (CYOD), or Bring Your Own Device (BYOD) device management models. The BYOD device management model may be of particular interest to some enterprises because such devices are owned by personal users, rather than being owned by the enterprise, as in the other device management models enumerated above.

Embodiments take advantage of current eSIM operations by storing geofence areas in the eSIM. Currently, a UE may store multiple eSIMs, with up to two active eSIMs at a given time. The active eSIMs may be auto-selected based on the data stored on the eSIMs, or by user-selection in some conditions. Embodiments may store geofence location data in the metadata of the eSIM. The location data may be accessible without activating the eSIM. More specifically, embodiments may store geofence data in the “Enterprise Configuration” portion of the metadata of the eSIM in accordance with current eSIM protocols.

The geofence location data describes one or more areas that establish the boundaries of the geofence. For example, the metadata may include a position, such as latitude and longitude, and a radius to define a circular geofenced area. The metadata may include multiple positions/radii to define multiple areas. Such areas may or may not overlap. Although the total amount of data to be stored on the eSIM to define the areas is not unlimited, the eSIM may be capable of storing up to ten or more such circular areas in accordance with embodiments disclosed herein. If a larger number of areas are desired, the location data may be further consolidated. For example, more areas may be stored by using a single radius for a plurality of different positions.

Embodiments herein are primarily described in terms of such circular geofenced areas defined by a position and radius; however, one of ordinary skill in the art will appreciate that embodiments should not be limited as such. Other parameters that define any desired polygonal boundaries for the geofence may be used. That is, the geofence data stored on the eSIM may be established by any means that allows the UE to compare its current position to the data to determine if the UE is within the area. For example, a collection of ranges of latitudes and longitudes may be used to define square polygons that established the geofenced areas.

Embodiments disclosed herein may provide a UE with the ability to seamlessly connect to an NPN that has been established over a given area by obtaining an eSIM. The UE may be provided the eSIM, for example, through an application or by scanning a QR code, and the UE may access the NPN analogously to how a UE might access a new Service Set Identifier (SSID) over a Wi-Fi connection.

The following is a glossary of additional terms that may be used in this disclosure:
Memory Medium—Any of various types of non-transitory memory devices or storage devices. The term “memory medium” is intended to include an installation medium, (e.g., a CD-ROM, floppy disks, or tape device; a computer system memory or random-access memory such as DRAM, DDR RAM, SRAM, EDO RAM, Rambus RAM), a non-volatile memory such as a Flash, magnetic media (e.g., a hard drive, or optical storage; registers, or other similar types of memory elements). The memory medium may include other types of non-transitory memory as well or combinations thereof. In addition, the memory medium may be located in a first computer system in which the programs are executed or may be located in a second different computer system which connects to the first computer system over a network, such as the Internet. In the latter instance, the second computer system may provide program instructions to the first computer for execution. The term “memory medium” may include two or more memory mediums which may reside in different locations (e.g., in different computer systems that are connected over a network). The memory medium may store program instructions (e.g., embodied as computer programs) that may be executed by one or more processors.
Carrier Medium—a memory medium as described above, as well as a physical transmission medium, such as a bus, network, and/or other physical transmission medium that conveys signals such as electrical, electromagnetic, or digital signals.
Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic.”
User Equipment (UE) (also “User Device,” “UE Device,” or “Terminal”)—any of various types of computer systems or devices that are mobile or portable and that perform wireless communications. Examples of UE devices include mobile telephones or smart phones (e.g., iPhone™, Android™-based phones), portable gaming devices (e.g., Nintendo Switch™, Nintendo DS™, PlayStation Vita™, PlayStation Portable™, Gameboy Advance™, iPhone™), laptops, wearable devices (e.g., smart watch, smart glasses), PDAs, portable Internet devices, music players, data storage devices, other handheld devices, in-vehicle infotainment (IVI), in-car entertainment (ICE) devices, an instrument cluster, head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine type communications (MTC) devices, machine-to-machine (M2M), internet of things (IoT) devices, and the like. In general, the terms “UE” or “UE device” or “terminal” or “user device” may be broadly defined to encompass any electronic, computing, and/or telecommunications device (or combination of devices) that is easily transported by a user (or vehicle) and capable of wireless communication.
Wireless Device—any of various types of computer systems or devices that perform wireless communications. A wireless device may be portable (or mobile) or may be stationary or fixed at a certain location. A UE is an example of a wireless device.
Communication Device—any of various types of computer systems or devices that perform communications, where the communications may be wired or wireless. A communication device may be portable (or mobile) or may be stationary or fixed at a certain location. A wireless device is an example of a communication device. A UE is another example of a communication device.
Base Station—The terms “base station,” “wireless base station,” or “wireless station” have the full breadth of their ordinary meaning, and at least includes a wireless communication station installed at a fixed location and used to communicate as part of a wireless telephone system or radio system. For example, if the base station is implemented in the context of LTE, it may alternately be referred to as an ‘eNodeB’ or ‘eNB’. If the base station is implemented in the context of 5G NR, it may alternately be referred to as a ‘gNodeB’ or ‘gNB’. Although certain aspects are described in the context of LTE or 5G NR, references to “eNB,” “gNB,” “nodeB,” “base station,” “NB,” and the like, may refer to one or more wireless nodes that service a cell to provide a wireless connection between user devices and a wider network generally and that the concepts discussed are not limited to any particular wireless technology. Although certain aspects are described in the context of LTE or 5G NR, references to “eNB,” “gNB,” “nodeB,” “base station,” “NB,” and the like, are not intended to limit the concepts discussed herein to any particular wireless technology and the concepts discussed may be applied in any wireless system.
Node—The term “node,” or “wireless node” as used herein, may refer to one more apparatus associated with a cell that provide a wireless connection between user devices and a wired network generally.
Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an Application Specific Integrated Circuit (ASIC), programmable hardware elements such as a field programmable gate array (FPGA), as well any of various combinations of the above.
Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, and the like). For example, LTE may support scalable channel bandwidths from 1.4 MHz to 20 MHz. WLAN channels may be 22 MHz wide while Bluetooth channels may be 1 Mhz wide. Other protocols and standards may include different definitions of channels. Furthermore, some standards may define and use multiple types of channels (e.g., different channels for uplink or downlink and/or different channels for different uses such as data, control information, and the like).
Band—The term “band” has the full breadth of its ordinary meaning, and at least includes a section of spectrum (e.g., radio frequency spectrum) in which channels are used or set aside for the same purpose.
Configured to—Various components may be described as “configured to” perform a task or tasks. In such contexts, “configured to” is a broad recitation generally meaning “having structure that” performs the task or tasks during operation. As such, the component may be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component may be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

### Example Wireless Communication System

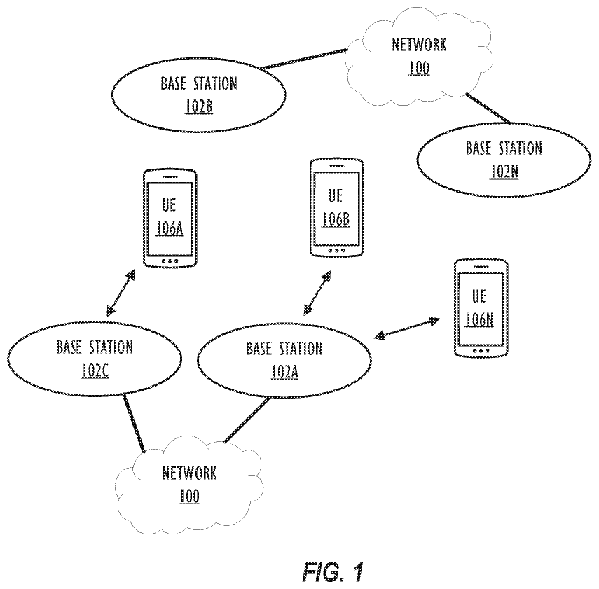

Turning now to FIG. 1, a simplified example of a wireless communication system is illustrated, according to some aspects. It is noted that the system of FIG. 1 is a non-limiting example of a possible system, and that features of this disclosure may be implemented in any of various systems, as desired.

As shown, the example wireless communication system includes a base station 102A, which communicates over a transmission medium with one or more user devices 106A and 106B, through 106N. Each of the user devices may be referred to herein as a “user equipment” (UE). Thus, the user devices 106 are referred to as UEs or UE devices.

The base station (BS) 102A may be a base transceiver station (BTS) or cell site (e.g., a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-A, 5G NR, HSPA, 3GPP2 CDMA2000. Note that if the base station 102A is implemented in the context of LTE, it may alternately be referred to as an ‘eNodeB’ or ‘eNB’. Note that if the base station 102A is implemented in the context of 5G NR, it may alternately be referred to as a ‘gNodeB’ or ‘gNB’.

In some aspects, the UEs 106 may be IoT UEs, which may comprise a network access layer designed for low-power IoT applications utilizing short-lived UE connections. An IoT UE may utilize technologies such as M2M or MTC for exchanging data with an MTC server or device via a public land mobile network (PLMN), proximity service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. As an example, vehicles to everything (V2X) may utilize ProSe features using a side link (SL) interface for direct communications between devices. The IoT UEs may also execute background applications (e.g., keep-alive messages, status updates, and the like) to facilitate the connections of the IoT network.

In V2X scenarios, one or more of the base stations 102 may be or act as Road Side Units (RSUs). The term RSU may refer to any transportation infrastructure entity used for V2X communications. An RSU may be implemented in or by a suitable wireless node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs (vUEs). The RSU may also include internal data storage circuitry to store intersection map geometry, traffic statistics, media, as well as applications/software to sense and control ongoing vehicular and pedestrian traffic. The RSU may operate on the 5.9 GHZ Intelligent Transport Systems (ITS) band to provide very low latency communications required for high-speed events, such as crash avoidance, traffic warnings, and the like. Additionally, or alternatively, the RSU may operate on the cellular V2X band to provide the aforementioned low latency communications, as well as other cellular communications services. Additionally, or alternatively, the RSU may operate as a Wi-Fi hotspot (2.4 GHz band) and/or provide connectivity to one or more cellular networks to provide uplink and downlink communications. The computing device(s) and some or all of the radio frequency circuitry of the RSU may be packaged in a weather enclosure suitable for outdoor installation, and it may include a network interface controller to provide a wired connection (e.g., Ethernet) to a traffic signal controller and/or a backhaul network.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B through 102N) operating according to the same or a different cellular communication standard may thus be provided as a network of cells, which may provide continuous or nearly continuous overlapping service to UEs 106A-106N and similar devices over a geographic area via one or more cellular communication standards.

Thus, while base station 102A may act as a “serving cell” for UEs 106A-106N as illustrated in FIG. 1, each UE 106 may also be capable of receiving signals from (and possibly within communication range of) one or more other cells (which may be provided by base stations 102B-102N and/or any other base stations), which may be referred to as “neighboring cells.” Such cells may also be capable of facilitating communication between user devices and/or between user devices and the network 100. Such cells may include “macro” cells, “micro” cells, “pico” cells, and/or cells which provide any of various other granularities of service area size. For example, base stations 102A and 102B illustrated in FIG. 1 may be macro cells, while base station 102N may be a micro cell. Other configurations are also possible.

In some aspects, base station 102A may be a next generation base station, (e.g., a 5G New Radio (5G NR) base station, or “gNB”). In some aspects, a gNB may be connected to a legacy evolved packet core (EPC) network and/or to a NR core (NRC)/5G core (5GC) network. In addition, a gNB cell may include one or more TRPs. In addition, a UE capable of operating according to 5G NR may be connected to one or more TRPs within one or more gNBs. For example, it may be possible that that the base station 102A and one or more other base stations 102 support joint transmission, such that UE 106 may be able to receive transmissions from multiple base stations (and/or multiple TRPs provided by the same base station). For example, as illustrated in FIG. 1, both base station 102A and base station 102C are shown as serving UE 106A.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, and the like) in addition to at least one of the cellular communication protocol discussed in the definitions above. The UE 106 may also or alternatively be configured to communicate using one or more global navigational satellite systems (GNSS) (e.g., GPS or GLONASS), one or more mobile television broadcasting standards (e.g., ATSC-M/H), and/or any other wireless communication protocol, if desired. Other combinations of wireless communication standards (including more than two wireless communication standards) are also possible.

In one or more embodiments, the UE 106 may be a device with cellular communication capability such as a mobile phone, a hand-held device, a computer, a laptop, a tablet, a smart watch, or other wearable device, or virtually any type of wireless device. Embodiments may also include vehicles, industrial equipment, or other devices that may benefit from multi-panel wireless connectivity.

The UE 106 may include a processor (processing element) that is configured to execute program instructions stored in memory. The UE 106 may perform any of the method aspects described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method aspects described herein, or any portion of any of the method aspects described herein.

The UE 106 may include one or more antennas for communicating using one or more wireless communication protocols or technologies. In some aspects, the UE 106 may be configured to communicate using, for example, NR or LTE using at least some shared radio components. As additional possibilities, the UE 106 could be configured to communicate using CDMA2000 (1×RTT/1×EV-DO/HRPD/eHRPD) or LTE using a single shared radio and/or GSM or LTE using the single shared radio. The shared radio may couple to a single antenna, or may couple to multiple antennas (e.g., for a multiple-input multiple output (MIMO) configuration) for performing wireless communications. In general, a radio may include any combination of a BB processor, analog RF signal processing circuitry (e.g., including filters, mixers, oscillators, amplifiers, and the like), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some aspects, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1×RTT, or either of LTE or GSM, among various possibilities), and separate radios for communicating using each of Wi-Fi and Bluetooth. Other configurations are also possible.

In some aspects, a downlink resource grid may be used for downlink transmissions from any of the base stations 102 to the UEs 106, while uplink transmissions may utilize similar techniques. The grid may be a time-frequency grid, called a resource grid or time-frequency resource grid, which is the physical resource in the downlink in each slot. Such a time-frequency plane representation is a common practice for Orthogonal Frequency Division Multiplexing (OFDM) systems, which makes it intuitive for radio resource selection. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid may comprise a number of resource blocks, which describe the mapping of certain physical channels to resource elements. Each resource block comprises a collection of resource elements. There are several different physical downlink channels that are conveyed using such resource blocks.

The physical downlink shared channel (PDSCH) may carry user data and higher layer signaling to the UEs 106. The physical downlink control channel (PDCCH) may carry information about the transport format and resource allocations related to the PDSCH channel, among other things. It may also inform the UEs 106 about the transport format, resource allocation, and HARQ (Hybrid Automatic Repeat Request) information related to the uplink shared channel. Typically, downlink scheduling (assigning control and shared channel resource blocks to the UE 102 within a cell) may be performed at any of the base stations 102 based on channel quality information fed back from any of the UEs 106. The downlink resource assignment information may be sent on the PDCCH used for (e.g., assigned to) each of the UEs.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH may be transmitted using one or more CCEs, depending on the size of the Downlink Control Information (DCI) and the channel condition. There may be four or more different PDCCH formats defined in LTE with different numbers of CCEs (e.g., aggregation level, L=1, 2, 4, or 8).

### Example Communication Device

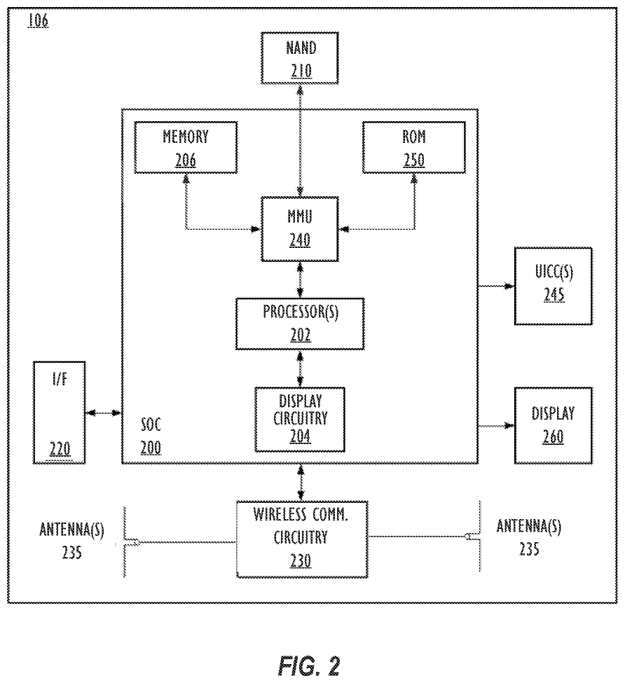

FIG. 2 illustrates an example simplified block diagram of a communication device 106, according to some aspects. It is noted that the block diagram of the communication device of FIG. 2 is only one example of a possible communication device. According to aspects, communication device 106 may be a UE device or terminal, a mobile device or mobile station, a wireless device or wireless station, a desktop computer or computing device, a mobile computing device (e.g., a laptop, notebook, or portable computing device), a tablet, and/or a combination of devices, among other devices. As shown, the communication device 106 may include a set of components configured to perform core functions. For example, this set of components may be implemented as a system on chip (SOC), which may include portions for various purposes. Alternatively, this set of components may be implemented as separate components or groups of components for the various purposes. The set of components may be coupled (e.g., communicatively; directly or indirectly) to various other circuits of the communication device 106.

For example, the communication device 106 may include various types of memory (e.g., including NAND flash 210), an input/output interface such as connector I/F 220 (e.g., for connecting to a computer system; dock; charging station; input devices, such as a microphone, camera, keyboard; output devices, such as speakers; and the like), the display 260, which may be integrated with or external to the communication device 106, and wireless communication circuitry 230 (e.g., for LTE, LTE-A, NR, UMTS, GSM, CDMA2000, Bluetooth, Wi-Fi, NFC, GPS, and the like). In some aspects, communication device 106 may include wired communication circuitry (not shown), such as a network interface card (e.g., for Ethernet connection).

The wireless communication circuitry 230 may couple (e.g., communicatively; directly or indirectly) to one or more antennas, such as antenna(s) 235 as shown. The wireless communication circuitry 230 may include cellular communication circuitry and/or short to medium range wireless communication circuitry, and may include multiple receive chains and/or multiple transmit chains for receiving and/or transmitting multiple spatial streams, such as in a MIMO configuration.

In some aspects, as further described below, cellular communication circuitry 230 may include one or more receive chains (including and/or coupled to (e.g., communicatively; directly or indirectly) dedicated processors and/or radios) for multiple Radio Access Technologies (RATs) (e.g., a first receive chain for LTE and a second receive chain for 5G NR). In addition, in some aspects, cellular communication circuitry 230 may include a single transmit chain that may be switched between radios dedicated to specific RATs. For example, a first radio may be dedicated to a first RAT (e.g., LTE) and may be in communication with a dedicated receive chain and a transmit chain shared with a second radio. The second radio may be dedicated to a second RAT (e.g., 5G NR) and may be in communication with a dedicated receive chain and the shared transmit chain. In some aspects, the second RAT may operate at mmWave frequencies. As mmWave systems operate in higher frequencies than typically found in LTE systems, signals in the mmWave frequency range are heavily attenuated by environmental factors. To help address this attenuating, mmWave systems often utilize beamforming and include more antennas as compared LTE systems. These antennas may be organized into antenna arrays or panels made up of individual antenna elements. These antenna arrays may be coupled to the radio chains.

The communication device 106 may also include and/or be configured for use with one or more user interface elements. The communication device 106 may further include one or more smart cards 245 that include SIM functionality, such as one or more Universal Integrated Circuit Card(s) (UICC(s)) 245 that store the eSIMs in accordance with embodiments disclosed herein.

As shown, the SOC 200 may include processor(s) 202, which may execute program instructions for the communication device 106 and display circuitry 204, which may perform graphics processing and provide display signals to the display 260. The processor(s) 202 may also be coupled to memory management unit (MMU) 240, which may be configured to receive addresses from the processor(s) 202 and translate those addresses to locations in memory (e.g., memory 206, read only memory (ROM) 250, NAND flash memory 210) and/or to other circuits or devices, such as the display circuitry 204, wireless communication circuitry 230, connector I/F 220, and/or display 260. The MMU 240 may be configured to perform memory protection and page table translation or set up. In some aspects, the MMU 240 may be included as a portion of the processor(s) 202.

As noted above, the communication device 106 may be configured to communicate using wireless and/or wired communication circuitry. As described herein, the communication device 106 may include hardware and software components for implementing any of the various features and techniques described herein. The processor 202 of the communication device 106 may be configured to implement part or all of the features described herein (e.g., by executing program instructions stored on a memory medium). Alternatively (or in addition), processor 202 may be configured as a programmable hardware element, such as a Field Programmable Gate Array (FPGA), or as an Application Specific Integrated Circuit (ASIC). Alternatively (or in addition) the processor 202 of the communication device 106, in conjunction with one or more of the other components 200, 204, 206, 210, 220, 230, 240, 245, 250, 260 may be configured to implement part or all of the features described herein.

In addition, as described herein, processor 202 may include one or more processing elements. Thus, processor 202 may include one or more integrated circuits (ICs) that are configured to perform the functions of processor 202. In addition, each integrated circuit may include circuitry (e.g., first circuitry, second circuitry, and the like) configured to perform the functions of processor(s) 202.

Further, as described herein, wireless communication circuitry 230 may include one or more processing elements. In other words, one or more processing elements may be included in wireless communication circuitry 230. Thus, wireless communication circuitry 230 may include one or more integrated circuits (ICs) that are configured to perform the functions of wireless communication circuitry 230. In addition, each integrated circuit may include circuitry (e.g., first circuitry, second circuitry, and the like) configured to perform the functions of wireless communication circuitry 230.

### Example Base Station

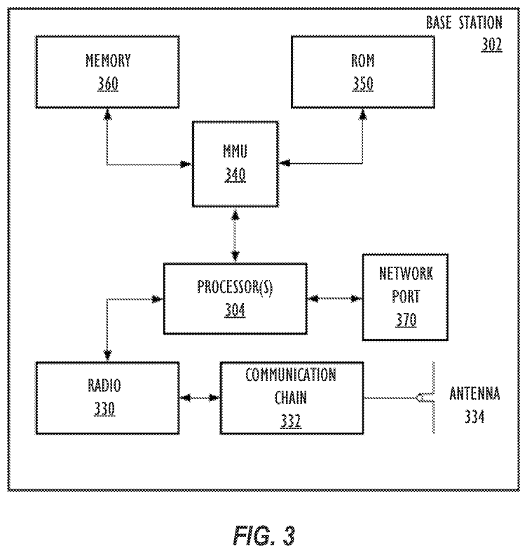

FIG. 3 illustrates an example block diagram of a base station 302, according to some aspects. It is noted that the base station of FIG. 3 is a non-limiting example of a possible base station. As shown, the base station 302 may include processor(s) 304 which may execute program instructions for the base station 302. The processor(s) 304 may also be coupled to memory management unit (MMU) 340, which may be configured to receive addresses from the processor(s) 304 and translate those addresses to locations in memory (e.g., memory 360 and read only memory (ROM) 350) or to other circuits or devices.

The base station 302 may include at least one network port 370. The network port 370 may be configured to couple to a telephone network and provide a plurality of devices, such as UE devices 106, access to the telephone network as described above in FIG. 1.

The network port 370 (or an additional network port) may also or alternatively be configured to couple to a cellular network, e.g., a core network of a cellular service provider. The core network may provide mobility related services and/or other services to a plurality of devices, such as UE devices 106. In some cases, the network port 370 may couple to a telephone network via the core network, and/or the core network may provide a telephone network (e.g., among other UE devices serviced by the cellular service provider).

In some aspects, base station 302 may be a next generation base station, (e.g., a 5G New Radio (5G NR) base station, or “gNB”). In such aspects, base station 302 may be connected to a legacy evolved packet core (EPC) network and/or to a NR core (NRC)/5G core (5GC) network. In addition, base station 302 may be considered a 5G NR cell and may include one or more transition and reception points (TRPs). In addition, a UE capable of operating according to 5G NR may be connected to one or more TRPs within one or more gNBs.

The base station 302 may include at least one antenna 334, and possibly multiple antennas. The at least one antenna 334 may be configured to operate as a wireless transceiver and may be further configured to communicate with UE devices 106 via radio 330. The antenna 334 communicates with the radio 330 via communication chain 332. Communication chain 332 may be a receive chain, a transmit chain or both. The radio 330 may be configured to communicate via various wireless communication standards, including 5G NR, LTE, LTE-A, GSM, UMTS, CDMA2000, Wi-Fi, and the like.

The base station 302 may be configured to communicate wirelessly using multiple wireless communication standards. In some instances, the base station 302 may include multiple radios, which may enable the base station 302 to communicate according to multiple wireless communication technologies. For example, as one possibility, the base station 302 may include an LTE radio for performing communication according to LTE as well as a 5G NR radio for performing communication according to 5G NR. In such a case, the base station 302 may be capable of operating as both an LTE base station and a 5G NR base station. When the base station 302 supports mmWave, the 5G NR radio may be coupled to one or more mmWave antenna arrays or panels. As another possibility, the base station 302 may include a multi-mode radio, which is capable of performing communications according to any of multiple wireless communication technologies (e.g., 5G NR and LTE, 5G NR and Wi-Fi, LTE and Wi-Fi, LTE and UMTS, LTE and CDMA2000, UMTS and GSM, and the like).

Further, the BS 302 may include hardware and software components for implementing or supporting implementation of features described herein. The processor 304 of the base station 302 may be configured to implement or support implementation of part or all of the methods described herein (e.g., by executing program instructions stored on a memory medium). Alternatively, the processor 304 may be configured as a programmable hardware element, such as a Field Programmable Gate Array (FPGA), or as an Application Specific Integrated Circuit (ASIC), or a combination thereof. Alternatively (or in addition) the processor 304 of the BS 302, in conjunction with one or more of the other components 330, 332, 334, 340, 350, 360, 370 may be configured to implement or support implementation of part or all of the features described herein.

In addition, as described herein, processor(s) 304 may include one or more processing elements. Thus, processor(s) 304 may include one or more integrated circuits (ICs) that are configured to perform the functions of processor(s) 304. In addition, each integrated circuit may include circuitry (e.g., first circuitry, second circuitry, and the like) configured to perform the functions of processor(s) 304.

Further, as described herein, radio 330 may include one or more processing elements. Thus, radio 330 may include one or more integrated circuits (ICs) that are configured to perform the functions of radio 330. In addition, each integrated circuit may include circuitry (e.g., first circuitry, second circuitry, and the like) configured to perform the functions of radio 330.

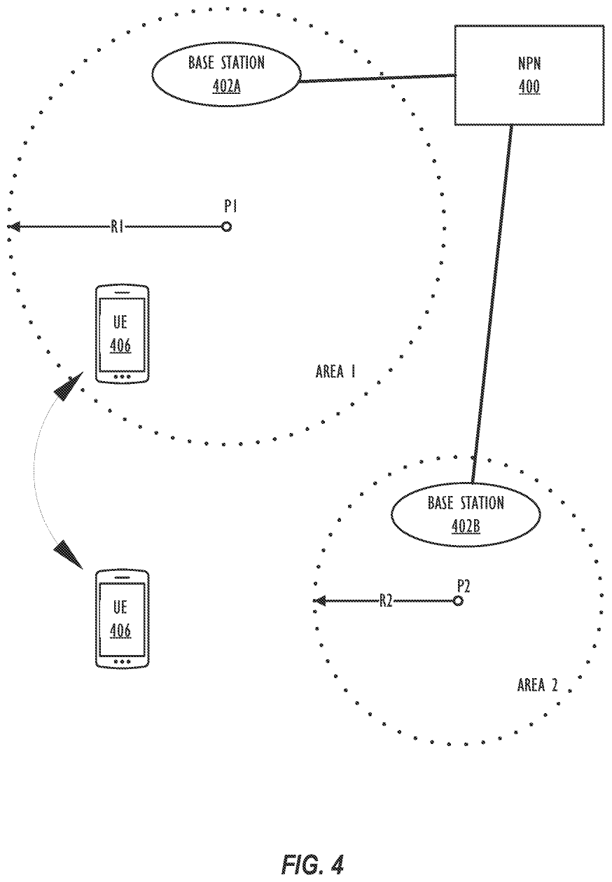

FIG. 4 illustrates an example map of NPN established geofencing areas, according to some aspects. The areas Area 1 and Area 2, shown in FIG. 4, illustrate two circular geofenced areas, in accordance with embodiments disclosed herein. Area 1 is defined by the coordinates of the point P1 and the radius R1. Similarly, Area 2 is defined by the coordinates of the point P2 and the radius R2.

One of ordinary skill in the art will appreciate that embodiments are not limited to just two areas, nor are embodiments limited to non-overlapping areas or circular areas only.

For example, a single Area may be defined as follows:

```
<key>Genofences</key>
<array>
  <dict>
    <key>Longitude</key>
    <real>−121.86313097825408</real>
    <key>Latitude</key>
    <real>37.25695030073826</real>
    <key>Radius</key>
    <real>20</real>
    <key>GeofenceId</key>
    <string>OPP</string>
  </dict>
```

FIG. 4 demonstrates a network NPN 400 (i.e., servers, etc.) that services the areas Area 1, Area 2. Each area includes at least one Transmission/Reception Point (TRP), shown as base stations 402A and 402B, whose coverage areas encompass the non-public network areas Area 1 and Area 2, respectively. In FIG. 4, the network NPN 400 is shown as being exterior to the areas Area 1 and Area 2; however, in many deployments, the NPN 400 may be located within one of the areas, or partially located in multiple areas.

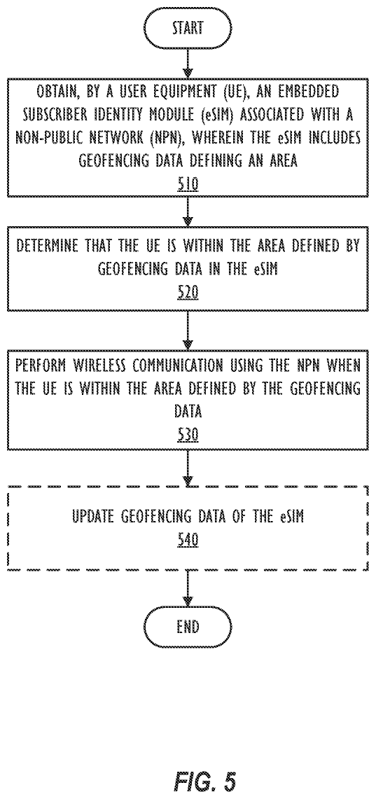

FIG. 5 demonstrates a basic flow chart for establishing geofenced UE services in an NPN, according to some aspects. In Step 510, the UE obtains an eSIM associated with the NPN. The eSIM may be installed in a UE by an administrator when setting up the UE to be issued to a user in device models provided by the enterprise. In embodiments that use a BYOD device model, the eSIM may be provided via a download to the UE, for example by scanning a QR code, accessing a website, accessing an application etc. In such embodiments, obtaining the eSIM may be accomplished through a point to point secured channel.

In Step 520, the UE determines that it is within an area defined by geofencing data stored on the eSIM. The UE may make the determination based on its current position compared to the location defined in the geofencing data. In embodiments disclosed herein, the geofencing data is stored in metadata of the eSIM that may be accessed by the UE without activating the eSIM. As shown in FIG. 4, the UE 106 may activate (or deactivate) the eSIM when entering (or exiting) the defined area (Area 1).

Currently accepted eSIM standards outline the data and format included in an eSIM and the metadata of the eSIM, for example a Profile Name, ICCID of the profile, Profile Policy Rules (PPR), etc. One such category that may be utilized to store the geofence data is the “Enterprise Configuration” portion of the metadata of the eSIM in accordance with some embodiments disclosed herein. The Enterprise Configuration is typically provided only if a profile is an enterprise profile. The Enterprise Configuration includes the name and rules associated with the enterprise profile.

Although embodiments have the advantage of not requiring the use of a geofence server, embodiments disclosed herein may still be used in conjunction with a geofence server. That is, the enterprise configuration could also include geofence server information. Thus, embodiments disclosed herein may provide a means to expand and/or supplement systems that utilize geofence servers.

In Step 530, the UE performs wireless communication with the NPN while within the geofenced area. Currently, a UE may have up to two active eSIMs. In some embodiments, one of the active eSIMs may be associated with the NPN as described herein, while the other active eSIM remains connected to a public network (i.e., PLMN network). That is, one of the active eSIMs may be reserved for access to the public network in order to receive calls and/or emergency services. Such a reservation may be necessary in order to comply with current laws and regulations.

The UE may be provided updates to the eSIM, as demonstrated in the optional Step 540. In accordance with embodiments disclosed herein, the eSIM may be updated via a request to obtain a new or an updated eSIM from the network. In some embodiments, an update to metadata of an eSIM may be provided by an operator in the NPN, for example, via an ES6 UpdateMetadata command to an eUICC of the UE, in accordance with current GMSA specifications. That is, embodiments may utilize an ES6 update (or other Operator-to-eUICC command) to push updates to the geofencing data to a UE.

In some embodiments, Mobile Device Management (MDM) operations may be used to update the geofencing metadata in the eSIM. That is, an eSIM may be updated/replaced as a part of the MDM services of an enterprise. In MDM operations, the administrator typically has sufficient authority over the eSIMs associated with the enterprise on the UE.

Aspects of the present disclosure may be realized in any of various forms. For example, some aspects may be realized as a computer-implemented method, a computer-readable memory medium, or a computer system. Other aspects may be realized using one or more custom-designed hardware devices such as ASICs. Still other aspects may be realized using one or more programmable hardware elements such as FPGAs.

In some aspects, a non-transitory computer-readable memory medium may be configured so that it stores program instructions and/or data, where the program instructions, if executed by a computer system, cause the computer system to perform a method (e.g., any of a method aspects described herein, or, any combination of the method aspects described herein, or any subset of any of the method aspects described herein, or any combination of such subsets).

In some aspects, a device (e.g., a UE 106, a BS 102) may be configured to include a processor (or a set of processors) and a memory medium, where the memory medium stores program instructions, where the processor is configured to read and execute the program instructions from the memory medium, where the program instructions are executable to implement any of the various method aspects described herein (or, any combination of the method aspects described herein, or, any subset of any of the method aspects described herein, or, any combination of such subsets). The device may be realized in any of various forms.

Although the aspects above have been described in considerable detail, numerous variations and modifications will become apparent to those skilled in the art once the above disclosure is fully appreciated. It is intended that the following claims be interpreted to embrace all such variations and modifications.

What is claimed is:

1. A method of geofencing in a wireless system, the method comprising:
receiving, by a receiver of a User Equipment (UE), an embedded Subscriber Identity Module (eSIM) associated with a Non-Public Network (NPN), wherein the eSIM includes geofencing data defining an area; and
performing wireless communication using the NPN when the UE is within the area defined by the geofencing data.

2. The method of claim 1, wherein the geofencing data is stored as metadata in the eSIM.

3. The method of claim 2, wherein the geofencing data is stored as part of an enterprise configuration of the metadata of the eSIM.

4. The method of claim 1, wherein receiving the eSIM further comprises: scanning, by the UE, a QR code to cause the download of the ESIM.

5. The method of claim 1, wherein the wireless system does not include a geofence server.

6. The method of claim 1, wherein the eSIM is one of two active eSIMs, the other active eSIM providing access to a Public Land Mobile Network (PLMN).

7. The method of claim 1, wherein the geofencing data comprises at least one of: a latitude, a longitude, and a radius.

8. The method of claim 1, wherein the geofencing data comprises: a plurality of geofencing locations.

9. The method of claim 8, wherein each geofencing location comprises: a latitude, a longitude, and a radius.

10. The method of claim 1, wherein the UE operates in a Bring Your Own Device (BYOD) device management model.

11. The method of claim 1, further comprising:
updating the geofencing data, by an operator, using an operator-embedded Universal Integrated Circuit Card (eUICC) connection.

12. The method of claim 1, further comprising:
updating the geofencing data via Mobile Device Management (MDM) operations.

13. A user device comprising:
a receiver that obtains an embedded Subscriber Identity Module (eSIM) associated with a Non-Public Network (NPN), wherein the eSIM includes geofencing data defining an area; and
a processor that determines the user device is within the area defined by the geofencing data to perform wireless communication using the NPN.

14. The user device of claim 13, wherein the geofencing data is stored as metadata in the eSIM.

15. The user device of claim 14, wherein the geofencing data is stored as part of an enterprise configuration of the metadata of the eSIM.

16. The user device of claim 13, wherein the eSIM is one of two active eSIMs, the other active eSIM providing access to a Public Land Mobile Network (PLMN).

17. The user device of claim 13, wherein the geofencing data comprises: a latitude, a longitude, and a radius.

18. The user device of claim 13, wherein the geofencing data comprises: a plurality of geofencing locations.

19. A wireless system comprising:
a Non-Public Network (NPN) server, the NPN server comprising:
a processor that embeds geofencing data in an embedded Subscriber Identity Module (eSIM) associated with an NPN
a user device comprising:
a receiver that obtains the eSIM associated with the NPN established by the NPN server, wherein the eSIM includes the geofencing data that defines an area; and
a processor that determines the UE is within the area defined by the geofencing data to perform wireless communication using the NPN.

20. The system of claim 19, wherein the system does not include a geofence server.
